(19) United States
(12) Patent Application Publication
(10) Pub. No.: US 2007/0261058 A1
(43) Pub. Date: Nov. 8, 2007

(54) Method and Means for Context-Based Measurement of Worked Time

(76) Inventor: Hans Robertson, Jonkoping (SE)

Correspondence Address: HARNESS, DICKEY & PIERCE, P.L.C., P.O. BOX 8910, RESTON, VA, 20195, US

(21) Appl. No.: 10/583,663

(22) PCT Filed: Dec. 21, 2004
(86) PCT No.: PCT/SE04/01966

§ 371 Date: Apr. 30, 2007

(30) Foreign Application Priority Data
Dec. 22, 2003 (SE) 0303566-4

(51) Int. Cl. G06F 9/46

(52) U.S. Cl. 718/108

(57) ABSTRACT

The present invention relates to a method and an arrangement for a first individual to report worked time based on his context log containing information about contextual aspects, related to the first individual, as a function of time. From information from the context log, a context graph of the first individual which shows contextual aspects as a function of time is generated, and at least a contextual aspect which refers to at least one location of the first individual and a contextual aspect which refers to at least one activity on a work- or individual-related objects with the same location as the first individual are included, and, for a task performed by the first individual during a certain period of time, a working account is selected, and, based on shown contextual aspects as a function of time, the period of time that is assessed to have been used for the task is marked in the context graph as allocated to the selected working account.

The present invention relates to a method and an arrangement for context-based measurement of worked time for an individual or a tool.

### BACKGROUND OF THE INVENTION

Our memory is not specially suited to remember in detail exactly which tasks we have accomplished during a day and how long time they have occupied.

Nevertheless, many people must report the time they have spent on a task for a customer and then send an invoice for the worked hours. If there are deficiencies and gaps in the particulars on which the invoice is based, both the customer and the person who accomplished the task may get into unpleasant situations.

In some cases, the organisation for which an individual works may want to have an accurate account of how long time is used for tasks, thereby creating a basis for checking of estimates against actual job costs. This may be needed, for instance, in order to learn to estimate the expected time for a task more and more precisely.

It may also happen that you want to know how a project develops in terms of time and cost so as to allow correction before the project advances in terms of cost too far in the incorrect direction.

As a rule, working time accounting occurs late and based on insufficient facts that have been created more or less manually. This means that considerable efforts have to be made to make the working time accounting as accurate as possible. You have to look for notes and facts and devote your time to thinking about what you actually accomplished. Alternatively, the working time accounting is made in a highly standardised manner. In none of these cases, the working time accounting will be very useful.

Many systems and methods have been suggested to facilitate the work of reporting time. They are often based on giving input data to a logging system, in advance or in the course of the work, in order to use such input data to create a report. Such a system is disclosed, for instance, in US 2003169230. The system may function when the number of different tasks is highly limited and if the same tasks are performed frequently, but good discipline is still necessary.

However, many people are busy with a variety of tasks. More often than not the variety is so complex, with tasks interlaced with each other, that it is not possible at a given moment to determine which is really the main task, especially what the main task will be for some time to come. Interruptions often occur, or other circumstances make it necessary to change tasks.

Only afterwards is it possible to make an assessment of what has happened and how the time has actually been used. However, the assessments will then in many cases be based on incomplete facts, and the longer the time that has passed the more difficult to achieve precision in the assessments.

Not only individuals must report their time. It may also be necessary to make separate working time accountings for expensive tools. Here, too, there are similar problems to determine for what the tool has been used.

There may be reasons to consider the discussed problems from a behavioural perspective.

The situation where we find ourselves affects and controls us consciously or unconsciously in our further actions. This controlling situation may be called the context in which we find ourselves. The context may be characterised by different aspects: where we are positioned, the individuals which are in our vicinity, the objects or tools, with what we are engaged, with which individuals we interact etc, but also for how long these features have existed and affected us. In aspects of context, it may also be included how we visualise the future, for instance how long time is available to achieve a certain result.

Our capability of observing different aspects of context is decent, but our capability of remembering in detail aspects of context is generally quite weak. It is difficult to remember straight away what we did an ordinary day a week ago and how our context changed during that day, and it may even be difficult to remember the same things of yesterday or even an hour ago.

The context may help us to remember, to make decisions, to make assessments, to plan and so on. By returning to the same place, we can be reminded of what we were doing there, by noticing a scent we can be reminded of things that we experienced when we noticed the same scent etc.

The context in which we find ourselves affects our behaviour and our decisions. As a rule we are pretty unaware of how this happens. If we have a good description as the function time of the context in which we have found ourselves, we can generally assess what we have done during a certain period of time and maybe also begin to understand the reasons why we did what we did. In that case, this might serve as guidance to realising what we need to do for the time to come, i.e. planning documentation.

A fairly detailed description of context makes it easier for us to remember and implies that we can later add aspects of context that are missing so that the description will be more complete. Especially when the completions must be based on our assessments, it is often easier to add them successively.

Active processing of this type may also lead to reflections and means that we will begin to understand why we are doing what we are doing. The more we refine the image of context, the easier it is to make the image more and more distinct. It means that if, also after a long time, you return to the image, the inner image of what happened exactly at that moment can be sharp. This creates a context that allows you to assess whether what you did on the occasion can be useful to the matter in which you are involved right now.

It may also result in the ability to reflect upon how you should have acted instead to arrive at a result that was better than the one actually obtained. If the context can be represented in distinct images, it would facilitate the work of processing, reinforcing and refining it as regards the past, present, and also future.

This type of context descriptions can sometimes be founding diaries, but most people find it too tedious to manually keep diaries detailed enough to allow for accounting of time. It also requires great discipline, and is time consuming.

### OBJECTS OF THE INVENTION

An object of the invention is to make it easy for an individual to determine the periods of time he has used for his respective tasks and report this on accounts associated with these tasks.

This is achieved by registering information about contextual aspects as a function of time, related to an individual, and from this creating an image, a context graph, which shows aspects of context for the individual as a function of time. This graph makes it easy for the individual to determine when he has worked on each task by the individual being able to carefully mark and measure, in connection with the graph, the respective periods of time in the graph, guided by the details of the graph. In order to increase readability and facilitate the interpretation of the context graph, it is designed so that the individual himself can supplement the graph with manual context marks.

It is also an object of the invention that the individual should be able to survey how his planned work contexts have been put into practice and, if the tasks have been estimated, provide quick feedback regarding how much of the estimated time has been worked.

The context log of the individual can be made more comprehensive and more distinct and thus useful for other purposes. This is achieved by letting information about the individual's supplementary contextual aspect marks and his marked work allocations be included in his context log.

By using for a tool, in applicable parts, means corresponding to those used for an individual, the ability to measure with great accuracy the used time of the tool and relating it to the task will be improved.

### DESCRIPTION OF THE INVENTION

Individuals and their environment are provided with tags with sensors which automatically can register aspects of context, for instance current location (place of presence), reachability via communication means, interaction with or use of tools, presence of or interaction with other individuals etc. By a tag is meant in this context a small electronic unit which can be allocated to individuals, objects, work objects, tools, premises etc, allowing them and their state to be detected automatically. The tags can communicate with, for instance by radio, physical networks or with other suitable means. The information from them is collected, buffered and compiled to make the information available for the individual, for example, in the computer or computers he uses in his work, or in a separate display.

The sensors generate information that can be expressed in contextual aspects and stored on a storage medium as a log and then processed to context graphs as a function of time for the members of the group. Such contextual aspects can be made available to the individual and comprise at least the past and present times, but may also comprise planned states for a contextual aspect for future times.

It is known to register such information that can be used to indicate an aspect of context.

U.S. Pat. No. 5,555,376 discloses how it is possible to collect contextual information which is there used for the purpose of controlling apparatus based on the context in which the user is positioned. EP 1217860 discloses how it is possible to collect contextual information in a log and use it to generate context-based suggested decisions to guide a user. US 2003013459 discloses how it is possible in an amusement park to follow a visitor's activities and collect information about his activities.

Registered contextual aspect information can be collected in a memory whose contents are then processed, sorted and compiled in a context log containing information about aspects of the person's context as a function of time. This log can then be processed and be made available in the form of a context graph. The context graph can suitably be displayed on a screen of a computer, on the display of an advanced mobile phone, a personal digital assistant or the like, or by a means capable of displaying an image. Interaction with the context graph can take place, for example, by means of a pointing device and a keyboard, or other input means.

Such graphs can show where the individual has been (place of presence), which other individuals were there at the same time, what tools have been active, the setting of the tool, the working posture used etc. If the tool is computer-like, it is possible to show for instance pointing device or key activities, active application, file name thereof, printout on printer, number of sheets printed etc.

An individual comes into contact with a number of work- or individual-related objects during a workday. Vehicles and tools may be involved, workpieces in the form of future products or parts of products that are processed, packed and delivered, incoming material or components that are processed etc. Also binders, furniture etc. that are used in work may be involved.

Individual-related objects can be a wallet, an article of clothing, a bunch of keys, a mobile phone, a personal digital assistant etc.

Objects as described above can be provided with tags and generate contextual aspects that may be included in the individual's log and then be used to generate traces in the individual's context graph, which makes it easy for him to keep track of what he was doing during the day.

When working with communication tools, it is possible to include, for instance, states and activities of these such as engaged, switched off, reachable only in certain ways, called person, dialled phone number or other addressing, called by an identified person, called by an identified phone number. The documentation which the individual produces in the course of the work by means of his tools (computer, mobile phone, personal digital assistant or the like) can also be marked and shown and be made available via the context graph. Also messages in text form, such as mail and SMS, or in image or sound form that have been exchanged with other individuals can be shown in the graph with explanatory text about the character of the message.

The log can also be used to show messages to itself, which may then have the character of notes and the mark can refer to the point of time when the message or note was stored in the context log. For example, it is possible to use a mobile phone and give a message and let this message be marked in the log at the point of time it was generated and let it be reproduced if the mark in the log is activated.

If it is advantageous, it is possible now and then to supplement the automatically registered aspects of context with manual ones in order to elucidate, when required, the image of what has happened. For instance, some individuals may not be provided with automatic means, and it may then be necessary to make manual marks for them.

It is also advantageous to be able to use the graph to show future aspects of context which are planned or expected to occur. Plans for activities or meetings may be involved. Once the point of time occurs when the planned time changes into present, it is advantageous to let the traces of the planning be included in the historical context graph to allow the planning to be compared with what actually happened.

All such context signals help the individual to remember what he has accomplished.

Based on the marks in this context graph, the individual can then mark the period of time during which he worked with a certain task and allocate it to a working account that he has chosen in connection with the context graph. In this manner, it is easy to provide a detailed account of working time.

The accounting of working time is suitably made now and then during the day while it is still easy to remember, by means of the context marks, what has been accomplished. The resulting working time account can then be stored in the same log and may then be included as part of the context log, thus accentuating it further.

The accounts can be summarized so that total worked time during the day is shown, total worked time from the beginning or for a specified calendar period. Estimated time can also be entered, and reduced by worked time, in order to show remaining time and also adjust it if is found to deviate from the estimation.

Not only people need to account for worked time. This applies also more important objects, such as working machines, expensive computer equipment, plotters and printers, exclusive work tools, etc. For these objects, context logs can be created in a similar way as for persons, and include context aspects regarding who has used them, for what, and for how long, and thereby provide guidance how to account for used time. Objects that are moved to the tool may also be traced, and the time during which the tool has been used for a certain object.

For documentation of different kinds, such as notes, recorded messages, files, images, video sequences and or other multimedia documentation, it is possible to use the context graph to relate the documentation to a contextual aspect shown in the context graph. This makes it easy for the individual to find it and to assess its relevance by means of the context with which it has thus been catalogued. When a plurality of individuals interact and exchange information, possibly based on contextual aspect, it may be important to include how other individuals or oneself has communicated regarding the documentation, for instance in the respects sent to, received from, opened by, checked by, read by, commented on by, printed by etc.

It is possible to distinguish between two types of information, a part that you want to share with others and matters that you want to keep to yourself, until further notice or permanently.

The documentation with which the individual comes into contact and which has relevance to the work or which he performs himself in the course of the work by means of his ordinary tools, can be catalogued in the context graph and allocated to the working account to which it belongs and to the point of time to which it was relevant. It can also be catalogued by means of one or more contextual aspects, such as account, individual, work- or individual-related object etc. Thus, the continuous documentation gets into a context which allows the context to be kept, which automatically gives the documentation a more distinct limitation. Once this documentation is included in the context, the context will be still more accentuated.

In the context graph the documentation can be indicated with an icon and, by interacting with the icon, it is possible to access the documentation. It is also possible to choose to access the documentation via one or more contextual aspects to which it has been catalogued. This means that there will be a distinct context log which can be graphically oriented, where it is possible to clearly follow your tasks and the documentation to which it has been connected. This makes it easy to repeat what happened during a day, and you will get clear associations to remind you also of matters that have not been documented.

This also means that the documentation will be put in order and be well structured, and by returning back in time via an account structure or a calendar, it will be possible to quickly find documentation connected to specific tasks. By documentation being catalogued and indicated in the context, also the individual's own reflections can be collected in such documentation and thus get into a clear context, which creates conditions for fast learning. Above all it will be easy to analyse how you interact with other individuals when cooperating and how you take up the time of others and how others take up your own time and how this affects the time it takes to perform a task and the effect on quality this may have. Also the observations made of this may then suitably be included as a part of the context log.

This advanced and accentuated context creates possibilities of analysing your own workday and also understanding why it developed as it did. For instance, it is possible to see the effect of frequent disturbances and interruptions and thus begin to realise how you should control your day to make it successful and also better understand how to interact with others.

### DESCRIPTION OF FIGURES

FIG. 1 illustrates a number of different types of tags that can be used to generate in an automated manner contextual aspect information that will be included in a context log.

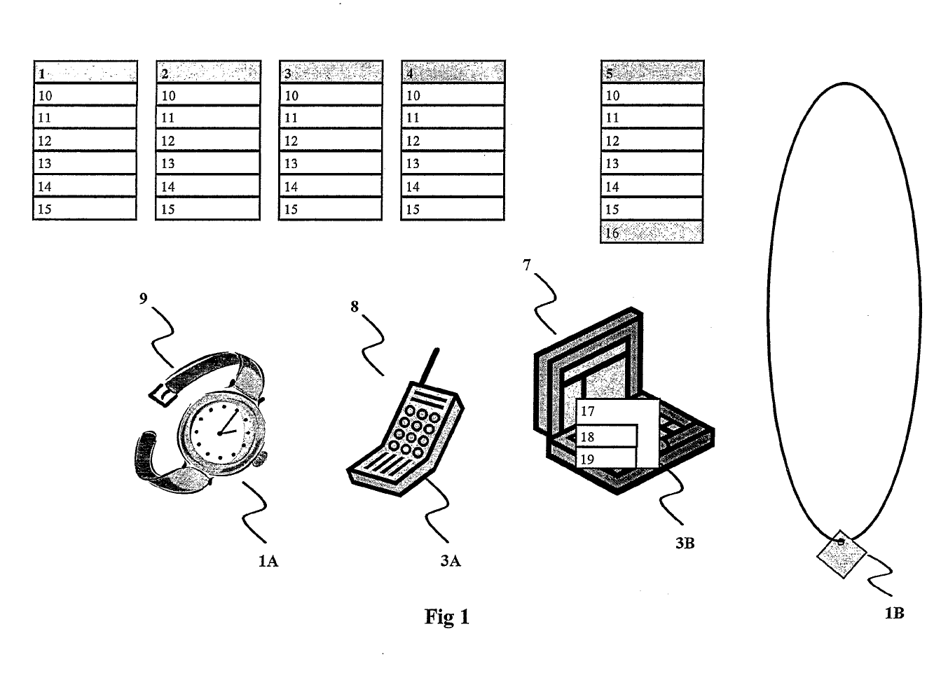

FIG. 2 illustrates how tags and network interact in a location to create a context log.

FIG. 3 illustrates how different types of network can interact to create context logs.

FIG. 4 illustrates how to use different means to create context logs in a workroom.

FIG. 5 illustrates how context logs can be created and handled and how different contextual aspects in different logs can be related to each other and thus be included in each other for an individual and for an object. The Figure also shows how it is possible to interact with a context graph.

FIG. 6 shows examples of how a number of individuals can exchange contextual aspect information so that no one will be informed about another individual's contextual aspects to a greater extent than the extent at which he himself has made corresponding contextual aspects available for a reciprocal period of time.

FIG. 7 exemplifies traces of context aspects in a context graph, and how this can be used for accounting of working tasks.

FIG. 8 shows examples of cataloguing documentation using context aspects in a context graph.

### DESCRIPTION OF EMBODIMENTS

In the following the invention will be described in a number of embodiments. They are to be regarded only as a few examples of a large number of variants of the invention and should in no way be considered to limit the invention.

The Figure illustrates the structure of a person tag 1, which can be provided with one or more antenna systems 10, one or more communication systems 11, one or more sensors 12, means for data processing and storage 13, and other analogue and digital electronics 14 used to make the different parts of the autolog cooperate. Finally there are power supply means 15, such as a battery or a connection to some other power supply. Some kind of protective encapsulation is also included.

The person tag can be an independent unit, for instance as illustrated by 1B where it has a cord and suitably can be worn around the neck, or it can be an integrated tag 1A in a watch 9. This type of tag is used for the individual to obtain automatic marks in his context graph and, to ensure this, a tag can therefore be allocated to one or more personal objects normally used by an individual in his daily work. It can be placed in a wallet, a mobile phone, a bunch of keys or the like.

Several types of tags have a more or less similar structure. The exact classification is not very important, and the following description is only exemplifying and does not comprise a complete enumeration.

A tag can be designed as an object tag 2. It can be used for different types of objects, for instance a work object which is to be processed and which is moved in a workroom between different tools. The object tag is conveniently provided with sensors that can indicate a movement or change. It can also be used to designate deliveries etc. It can also be used to designate important binders or instructions.

Another tag can be a tool tag 3 which is attached to tools that are particularly important in the business, for instance a mobile phone, a special instrument, a tool, a computer or the like. If a telephone is involved, the sensors 12 of the tag can be adapted to detect whether the telephone is engaged in a call. A tool tag can also be used to mark working furniture, in which case its sensors can detect the working posture or setting of furniture.

Yet another type of tag is a position tag 4 which is permanently attached in a position to indicate its identity for the context log. Sensors 12 can be used, for example, to detect light and temperature in the position. A position tag 4 can have its own power supply 15 connected to permanent electric mains, but can also be operated by a battery. A variant of this position tag can have a sensor consisting of a GPS receiver, thus allowing the tag to keep track of its geographic position.

A special type of tag is a log tag 5 which can be provided with one or more antenna systems 10, one or more communication systems 11, one or more sensors 12, means for data processing and storage 13, and other analog and digital electronics 14 used to make the different parts of the autolog cooperate. The power supply 15 may consist of, for instance, a battery or a connection to some other power supply. There are also means for storing of logged information 16.

A tag can be built into or integrated with an object normally used by the individual in his work, for instance a watch 9 with a tag 1A, a mobile phone 8 with a tag 3A, or a mobile computer 7 with a tag 3B.

For the objects which are of the tool type, a tool tag 3 or a log tag 5 can often be integrated with the hardware and can, in the extreme case, consist of software. This may be the case, for example, when the tool is a computer 7, but may also apply to a qualified mobile phone 8 or a personal digital assistant or some other tool with a qualified data processing and communication capacity.

The tag program 17 is integrated in the software of the computer 7. The sensor part 18 in the software generates information about how the computer is used, about the documentation generated and about the interaction with log information which the individual performs by means of the tool. The communication part 19 is used in the program to transmit information to the place or the places where the context log then is to be stored and where it is included in the same.

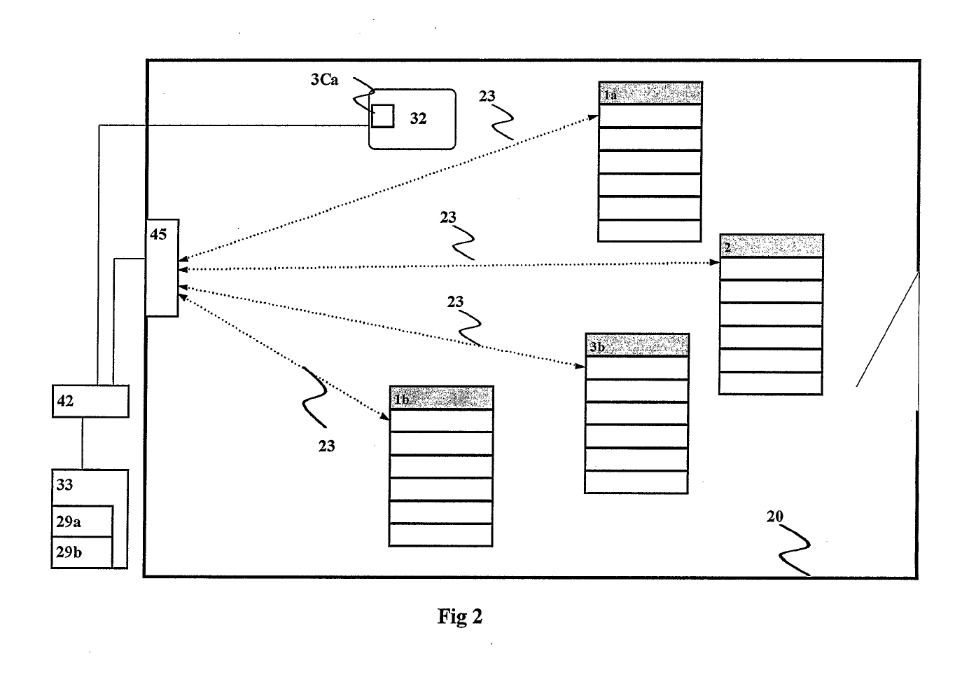

As is evident from FIG. 2, a person tag 1a is located in a place 20 where at the same time a work object tag 2, a tool tag 3b and a network-connected computer 32, belonging to the individual 1a, with an integrated software tag 3Ca are located. There is also a person tag 1b carried by another individual who is in the room at the same time.

In the room there is a gateway 45. The tags communicate with the gateway 45, which preferably occurs as encrypted messages 23. When a person tag 1a is within the communication range of the gateway 45, the gateway can establish which other tags 2, 3a and 3b are at the same time positioned in the same room and which other person tag or tags 1b are positioned there at the same time.

Via the network 42, there can now in the server 33 be generated information in the context logs 29a and 29b for the individual with the person tag 1a and for the individual with the person tag 1b with essential information as a function of time. Context information can then be used to generate context graphs which can be sent via the network to other individuals.

In particular the individual with the person tag 1a can use his information in the context log 29a to show a context graph in the computer 32 and use it in support of work allocation and documentation and let the integrated tag 3Ca communicate information about this directly to the network so that information about this is included in the context log 29a.

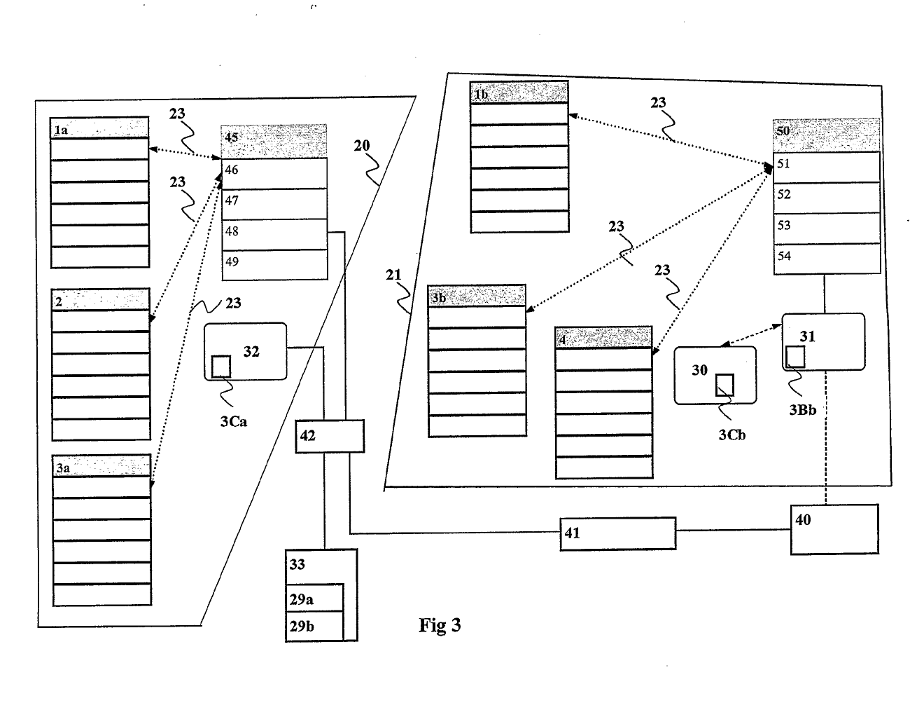

FIG. 3 illustrates how communication related to person tags can be used to generate a context log 29a for the individual who has the person tag 1a and is located place 20 and a log 29b for the individual who has the person tag 1b and is located in the place 21 and transfer them to environments where they can used to generate contextual aspect information, for example in the network-connected computer 32 provided with an integrated software tag 3Ca.

The gateway 45 has one or more antenna systems 46, one or more radio systems 47 and other electronics 48 for indications, data processing, communication and encryption and cofunction. It also has means for power supply 49, generally permanently, but in some cases a battery or some other power supply not connected to mains may be preferred. The gateway 45 is used to transfer encrypted messages 23 from the person tag 1a when it is positioned within the communication range of the gateway 45. At the same time the gateway 45 can perceive communication from the other tags, the work object tag 2 and the tool tag 3a, which are within its communication range.

Information from the gateway 45 related to the person tag 1a is transferred via the network 42 to the server 33 where a log 29a is generated for the individual, from which it is apparent through which fixed gateway 45 the information has come, which in turn identifies the room where the individual has been positioned. Location information can also come directly from the person tag 1 if it is provided with sensors for determining the position in the room or the geographic position.

In the log 29a for the individual in the server 33, there is also added information about which other tags, work object tag 2 and tool tag 3a, were located in the room at the same time and tags of any other individuals which were also located there. The individual with the person tag 1a can then in the network-connected computer 32 directly via the network 42 interact with his log 29a and the integrated software tag 3Ca can include information about such interaction with the log 29a.

For an individual located in the place 21 and who is not positioned within the communication range of a fixed gateway, it may instead be possible to use a mobile network 40 and have a gateway 50 which is connected to a mobile phone 31. The gateway 50 has one or more antenna systems 51, one or more radio systems 52 and other electronics 53 for indications, data processing, communication and encryption and cofunction. It also has means for power supply 54.

Analogously to that stated above, the person tag 1b, the tool tag 3b and the GPS position tag 4 can communicate with the gateway 50 via the mobile phone 31 and the mobile phone network 40 reach the network connection 41 to the fixed network 42 and its server 33 and there generate a context log 29b for the person tag 1b. In this case, information from the GPS position tag 4 can then be used to define the place 21 where the individual has been located and include this in the context log 29b of the individual. Some mobile phone networks can determine the position of the mobile phone by other methods, and in that case this information can alternatively be collected from the mobile phone operator or from the mobile phone.

The information in the logs 29a and 29b in the server 33 can then be shown on a network-connected computer 32 with the software tag 3Ca or on the mobile phone 31 with the software tag 3Bb. Alternatively, the information can be transferred via the mobile phone 31 to a mobile computer 30 with the software tag 3Cb. Especially if the mobile computer is used at the same time as a tool to compile documentation in the work, this is a convenient and practical solution. When the individual with the person tag 1b interacts with his context log 29b via the mobile computer 30 or the mobile phone 31, information about this can be included in the context log 29 by means of the integrated software tags 3Cb and 3Bb respectively.

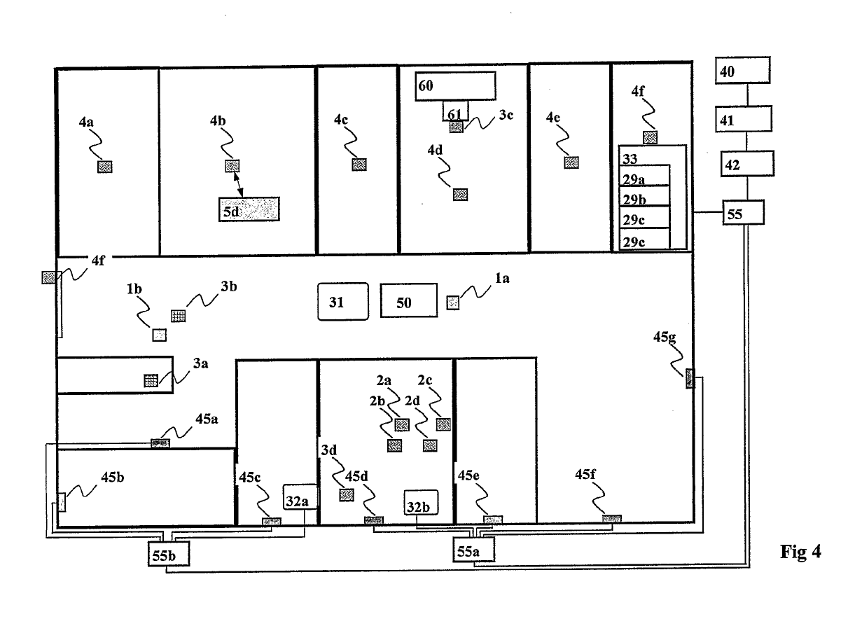

FIG. 4 illustrates what it may look like in a workroom with a plurality of locations (places of presence) where a large number of different tags are positioned, fixed gateways 45a-45g, position tags 4a-4f, tool tags 3a-3d are used and also person tags 1a-1b and a log tag 5d are used.

In the room there is the server 33 which stores information for the logs 29a-29d belonging to the individuals having the respective person tags 1a-1b and log tag 6d. There are also the work object tags 2a-d, which are processed in a machine having the tool tag 3d. The server 33 is connected to the network via the switch 55, which in turn is connected to other switches 55a and 55b conducting the network to the gateways 45a-45g. In the room there are parts with more or less complete coverage of gateways 45a-g. In these areas, it is then possible to continuously generate a complete log in the server 33.

On the occasions the individual is positioned outside the range of the gateways and also has no contact with a mobile network, in the manner illustrated in FIG. 3 and in FIG. 4, information can be stored locally in the log tag 5d. The log 29d can also establish that there is currently no contact with the log tag 5d. The log tag 5d is then assisted by the other tags in the room, for instance the furniture tag 3c which is attached to a chair 61 placed at a desk 60, the position tags 4a-4f. The latter are used to indicate the places of presence that are associated with the respective position tags.

As soon as the log tag 5d is within the range of communication of the gateway 45a-g or, optionally, the mobile gateway 50, information can be transferred from the log tag 6d to its context log 29d in the server 33.

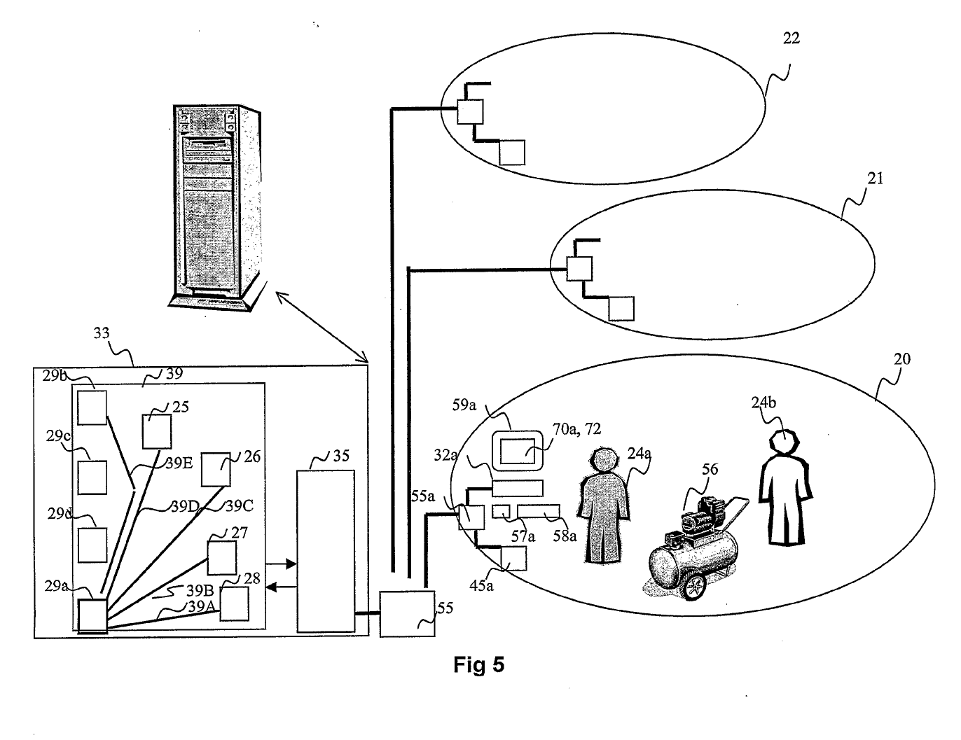

FIG. 5 exemplifies how an individual 24a is located with another individual 24b in a location 20. Information from the context in which the individual 24a is positioned is collected via tags (not shown) from individuals, furniture, tools etc. that are positioned in this location and communicate with the gateway 45a via the switch 55a and 55 to the server 33. These contextual aspects are stored by processor means 35 in the log 29a.

Some alternative locations 21 and 22 for the individual 24a are also indicated in the Figure. Here, too, there is, as indicated, communication with the server 33 via gateways and switches. Information from the context log 29a has been processed by the processor means 35 in the server 33 and presented as a contact graph 70a to the individual 24a on a screen 59a connected to the computer 32a.

A work- or individual-related object 56 is also positioned in the location 20. It is provided with a tool tag (not shown) which can communicate with the gateway 45a and supply its contextual information in the form of a log 27 containing information about contextual aspects related to the object 56. Some of this information is related to the individual 24a via the relation 39B, which means that it will also be included in the log 29a.

Step by step as the individual 24a works, he can guided by the context graph 70a by means of the computer 32 and its pointing device 57a and also its keyboard 58a manually insert supplements to that shown in the context graph 70, such marks being included in the context log 29a and presented in the now accentuated context graph 70a.

The context graph 70a shows graphical traces as a function of time of activities for the object 56. Step by step as various tasks are being performed, the individual 24a can now by means of the pointing device 57a and the keyboard 58a mark the period of time he estimates, guided by the traces in the graph, to have used for a certain task and allocate it to a working account. This information is then saved in the server 33 by processor means 35 in the form of contextual aspect information concerning allocation in the log 26. It is related to the log 29a via the relation 39C, which means that it will also be included in the log 29a. It also means that the context graph can now be still more accentuated.

The documentation performed by the individual 24a while working by means of the computer 32 can be catalogued based on contextual aspects in the context graph 70a. The documentation is indicated by means of an icon in connection with the contextual aspect which is shown in the context graph and to which the individual has chosen to relate it. This may involve, for instance, an observation of what happened to the object 56 just after the work was begun or comments on problems with the task which has been performed and which may need be documented. In this case, it can be natural to catalogue the documentation so that it will be allocated to the working account that is used for the task. The information of the documentation is stored in the server 33 in the documentation log 25. It is related to the log 29a via the relation 39D, which means that it will also be included in the log 29a. It also means that the context graph will now be more accentuated.

On the storage medium 39 information is also stored about the contextual aspects which the individual 24a is not willing to share with other individuals or groups of individuals. Information about this is stored in the log 28 and is related to the log 29a via the relation 39A, which means that this information thus is also included in the log 29a. By means of this information it is controlled, for instance, if the individual 24b is visible in the context graph of the individual 24a when they are located in the same location.

For information collected in the context log 29b of the individual 24b, some information may have been shared with the individual 24a. This has been indicated with the relation 39E and such information from the log 29b will then be included in the log 29a. An example of how to arrange this will be described with reference to the next Figure.

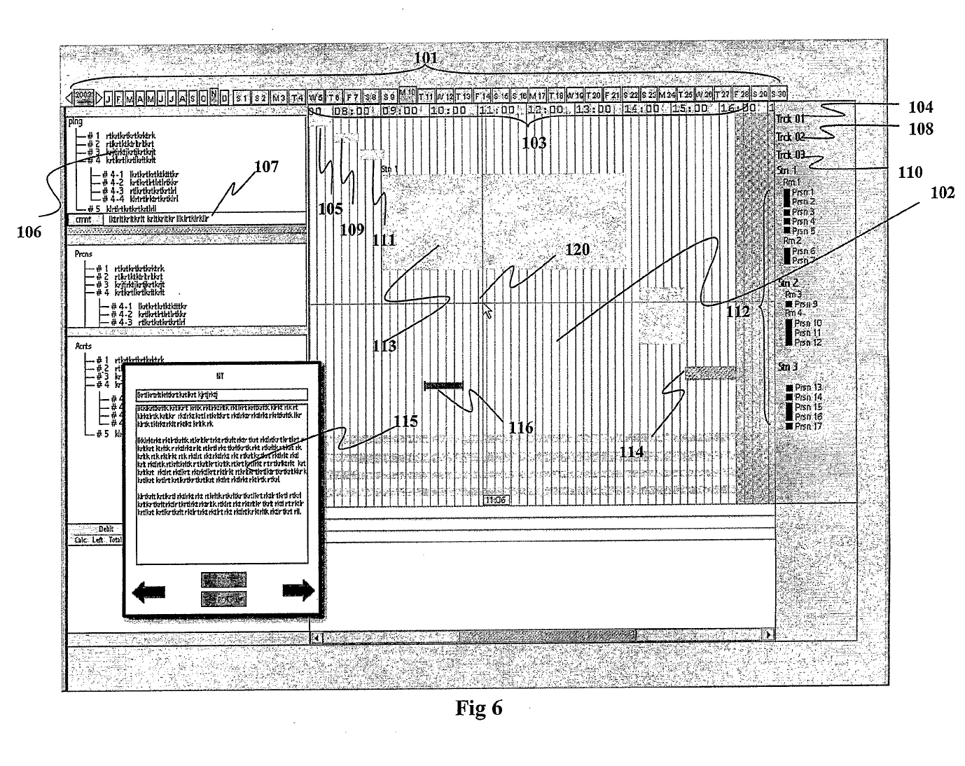

FIG. 6 shows an example of how information from a context log can be used to create a context graph of an individual.

In the following it is shown how the context graph is used for planning. Planning information thus generated is then included in the individual's context log for the future.

At the top there is a calendar controller 101 by means of which it is possible to select year, month and day of the month. A day is selected by activating the respective buttons by means of the cross hairs 120 and planning can thus be made for the day in question. In the upper right part 102 there is a planning and presence plate which can accommodate planning strips and presence traces. Above the same there are indications of time 103 which show the time that applied to the respective strips and traces. The uppermost line 104 is used to indicate absence such as sickness, holiday or the like. There a strip 105 can be inserted indicating the time when an individual is absent or plans to be absent and also an explanatory text indicating the type of absence.

The planning instrument is selected in the planning box 106 at the top to the left. There it is possible to select the type of planned absence. By marking a certain type it is then possible to generate by means of the cross hairs 120 a strip for a relevant range and insert an explanatory text in the comment field 107 in the lower part of the planning box. The next line 108 is used to mark that the individual intends to work in another place where he will not be seen in the system. He makes a choice in the planning box and marks a light grey strip 109 along the line relevant time and can insert explanatory text in the comment field. The next line 110 is used when an individual intends to work in a special place to which there is a gateway, thus enabling automatic registering in the system. In the same way as before, he makes a choice in the planning box 106 and marks the range 111 along the line and adds any information in the comment field 107.

Then follow three line sections 112 which designate workplaces which are connected by gateways and where automatic log marks can be expected. Once more, a choice is made in the planning box 106, the current range is marked with a strip 113 and any comments are inserted. It is here possible to select specific rooms—for instance a conference room—which can then be marked with a strip 114 of a slightly deviating character.

If it is desirable to add a note, this can be done by pointing at a place and time and clicking twice. Then the note box 115 at the bottom to the left is activated and comments can be inserted, which are saved by a mark 116 on the selected place. The mark 116 can be adjusted to provide an extent corresponding to a current period of time and it can be inserted in the graph so that it corresponds to a place or an individual, if desired, in order to elucidate the context.

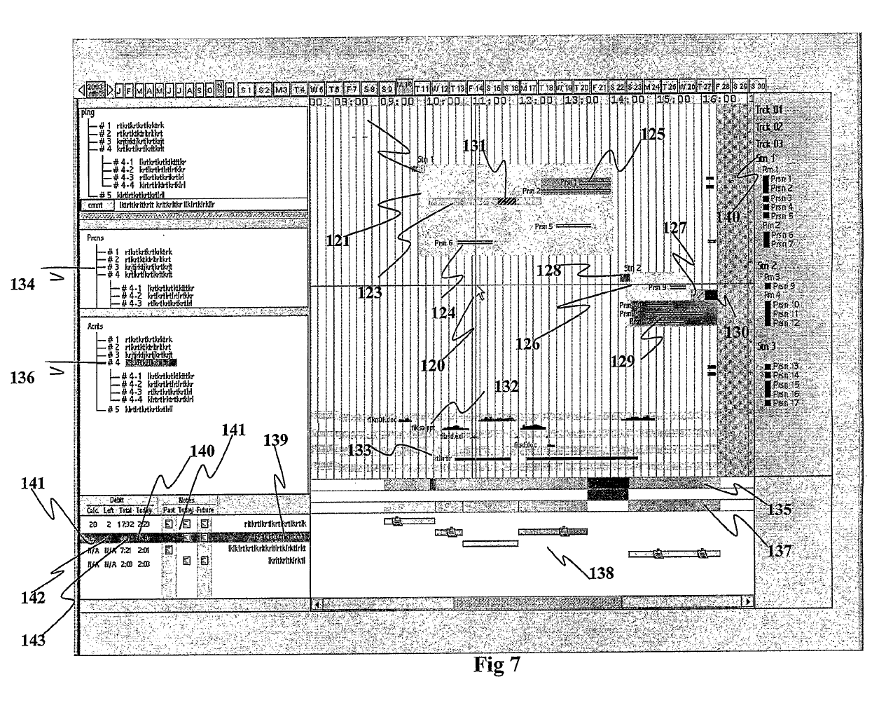

FIG. 7 shows how on a day, in which a planning has been drawn up, contextual aspects are shown as traces in the context graph.

The individual in question has planned 121 to arrive at work in the working place 140 just before 10 a.m. It can be seen that this is shown as a mark 122 on the first trace which designates the entrance of the workplace. Then he has walked to his own workroom and this locality 123 obtains a wide mark. While he is sitting there, another individual pays a visit, which is marked with a separate trace 124 corresponding to that individual. After a while he walks to a room where two individuals have their workplace and this is marked by the trace 125. Only one of the individuals normally sitting in the room is initially present, which is to be seen as marked in the room trace. The other individual arrives after a while.

In the afternoon, the individual has planned to be in another workplace, which is marked by the strip 126, and, at the end of the day, sit in a conference room 127 there. He arrives at the entrance somewhat earlier than planned 128 and finds a workroom 129 where three individuals usually sit and the respective traces indicate for how long during the visit each individual has been present. Then the individual walks to the conference room 130, and in the conference room there are at the same time a plurality of individuals, also individuals having their workplace in other places and being indicated at the corresponding time.

If an individual speaks on the telephone for a certain time, this can be indicated 131 in the log if a telephone activity is detected by a tag or information is supplied to the context log in some other manner, for instance by a telephone operator.

Below room and the individuals' lines, there is an area where work on an individual's own computer or on other tools can be indicated. In this case, keyboard and pointing device activities are indicated 132 when working on some files that have been indicated by names. One of the traces indicates a tool 133 and here two different activities are to be seen, which have been indicated with alternative traces.

In the presence/absence box, it is possible to mark actual presence/absence by selecting in the tree structure 134. The corresponding time can then be marked in the line 135 for presence/absence where also lunch and private time can be selected and marked. All this is marked by the cross hairs 120. After that working accounts can be selected in the account box 136 and marked on the allocation line 137. At the same time, marking traces are generated, one line for each account 138 below the allocation line.

The marking traces are provided with account designations 139 and the total time of the account during the day is summed up 140 and shown. If the task has been estimated, this can be shown in the position 141. The totally charged time is shown in the position 143 and how much remains is evident from 142. Here the remaining time can be adjusted by clicking twice on the box 142. This may be convenient if the time that is estimated to remain deviates from the difference 142 between estimate 141 and processing 143.

All information inserted is included in the individual's context log.

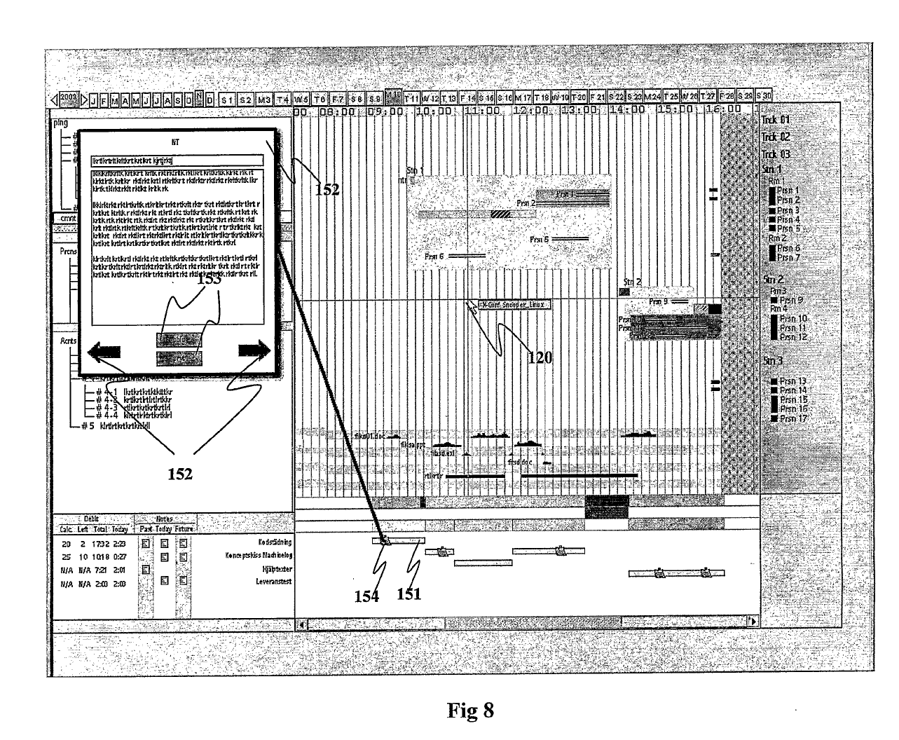

FIG. 8 shows how, by clicking twice on an account marking line 151, the note box 152 is activated so that documentation can be inputted, which is related to the task. At the same time a note icon 154 is generated, indicating that a documentation is catalogued with the account as contextual aspect.

At the bottom edge of the note box there are arrow keys 152 to make it possible to move forward and backward to a preceding (or subsequent, if looking at a historical day) documentation related to the same account. A corresponding icon is then marked, and if there is documentation on another day, the context graph changes the day automatically.

Documentation can thus be allocated with contextual aspects such as account, time, current location (place of presence), presence of other individuals in the same location and the documents that have been worked with. It will then be easier to remember and find the context in which the documentation was executed and, thus, find the documentation. To open a note indicated in the context graph, it must just be focused with the cross hairs 120 and clicked twice. It can also be reached by interaction with some other suitable contextual aspect that is indicated in the context graph for the same time.

It is possible to mark by the buttons 153 if the documentation should be public or private. If it is public, it can be communicated to other individuals who, for instance, work with the same task.

1. A system for associating time with a specific task, comprising
a plurality of sensors arranged on a person or an object and the person's/object's surroundings, said sensors regularly detecting location of said person/object, any additional persons/objects in said location, and any activity performed in said location,
communication means arranged to collect and to store data from said sensors in a context log relating to said person/object,
processing means arranged to select and process data from said context log and to generate a context graph displaying location and/or activity for said person/object as a function of time, and
presentation means for making said context graph visually accessible,
wherein
selection means for marking a time period in said context graph, and for associating said time period with a representation of said task appearing on said presentation means.

2. System according to claim 1, wherein said processing means further are arranged to calculate the total of all marked time during a day for tasks belonging to a specified working account, and wherein said presentation means are arranged to present said calculated time adjacent said context graph.

3. System according to claim 2, wherein said processing means further are arranged to adjust a precalculated time for the working account in accordance with said calculated total time, and wherein said presentation means are arranged to present said adjusted time adjacent said context graph.

4. System according to claim 1, wherein said processing means are arranged to receive information about documentation associated with data in said context graph, and to catalogue said documentation based on its association with said context graph.

5. A method for associating time with a specific task, comprising
detecting, by means of a plurality of sensors arranged on a person or an object and the person's/object's surroundings, a location of said person/object, any additional persons/objects in said location, and any activity performed in said location,
collecting and storing data from said sensors in a context log relating to said person/object,
selecting and processing data from said context log and generating a context graph displaying location and/or activity for said person/object as a function of time, and
making said context graph visually accessible,
wherein
marking a time period in said context graph, and
associating said time period with a representation of said task appearing on said presentation means.

6. Method according to claim 5, further comprising calculating the total marked time during a day for tasks belonging to a specified working account, and presenting said calculated time adjacent said context graph.

7. Method according to claim 6, further comprising adjusting a precalculated time for the working account in accordance with said calculated total time, and presenting said adjusted time adjacent said context graph.

8. Method according to claim 5, further comprising receiving information about documentation associated with data in said context graph, and cataloguing said documentation based on its association with said context graph.
